(19) United States
(12) Patent Application Publication
(10) Pub. No.: US 2021/0386232 A1
(43) Pub. Date: Dec. 16, 2021

(54) HOLDER FOR A BUTTER-LIKE PRODUCT

(71) Applicant: Bryan M. Pinchuk, Miami, FL (US)

(72) Inventor: Bryan M. Pinchuk, Miami, FL (US)

(21) Appl. No.: 17/344,704

(22) Filed: Jun. 10, 2021

Related U.S. Application Data
(60) Provisional application No. 63/039,255, filed on Jun. 15, 2020.

(51) Int. Cl. A47J 9/00; A47G 19/26

(52) U.S. Cl. CPC A47J 9/001; A47G 19/26

(57) ABSTRACT

A device is provided for holding a butter-like product packaged as an elongate solid or semi-solid stick or bar. The device has a base with opposed first and second sides. At least one anchor extends from the first side of the base, and an elongate handle extends from the second side of the base. The at least one anchor is configured for insertion into the butter-like product such that the device can hold and support the butter-like product. The handle is configured to be gripped or otherwise held by a user's hand for moving and maneuvering the device with a butter-like product secured thereto during use. The base is configured to interface to an end part of the butter-like product supported by the at least one anchor during use and also functions as a drip guard during use. Other aspects are described and claimed.

### CROSS-REFERENCE TO RELATED APPLICATION(S)

The present disclosure claims priority from U.S. Provisional Appl. No. 63/039,255 filed on Jun. 15, 2020, herein incorporated by reference in its entirety.

### BACKGROUND

### 1. Field

The present disclosure relates to articles for holding butter or butter-like products.

### 2. State of the Art

Butter, butter substitute, margarine, or shortening (referred to herein collectively as butter-like products) are packaged as an elongate solid or semi-solid stick or bar. It is often desirable to hold such butter-like products using a tool or method in which the user's fingers or hands do not come in contact with the product itself. One such use is spreading a butter stick either on a hot pan, a cold tray, or crackers. Current methods require the user to grasp the butter itself or employ a liner such as a paper towel or wax paper, to avoid touching the butter; in addition, the butter stick often drips all over and creates a mess. Another method would involve holding the butter with a fork or other utensil, but this will create the risk of scratching the surface of the pan and the constant stabbing of the stick would ultimately crumble the butter if careful attention to use the same holes each time is not utilized.

There is thus the need for improvements in devices and methods that hold a butter-like product during use.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In accordance with aspects herein, a device is provided for holding a butter-like product packaged as an elongate solid or semi-solid stick or bar. The device has a base with opposed first and second sides. At least one anchor extends from the first side of the base, and an elongate handle extends from the second side of the base. The at least one anchor is configured for insertion into the butter-like product such that the device can hold and support the butter-like product. The handle is configured to be gripped or otherwise held by a user's hand for moving and maneuvering the device with the butter-like product secured thereto during use. The base is configured to interface to an end part of the butter-like product supported by the at least one anchor during use and also functions as a drip guard during use.

In embodiments, the at least one anchor can include a plurality of elongate members configured for insertion into the butter-like product during use. For example, the plurality of elongate members can be generally straight posts with round bulbous heads. In another example, the plurality of elongate members can be straight spikes, tapered spikes, columns, saw-toothed, serrated, or otherwise shaped or textured spikes.

In embodiments, the at least one anchor can include a cross-shaped anchor, a plurality of L-shaped anchors, or a plurality of curvilinear-shaped anchors.

In embodiments, at least the anchor of the device or the entire device can be realized from a food-grade material, such as silicone, Teflon, phenolic, Nylon, wood, or Kraton.

In embodiments, the at least one anchor has a length of at least 0.4 inches or more.

In embodiments, the at least one anchor is configured to support and hold the butter-like product in response to direct forces applied to the butter-like product. The least one anchor can also be configured to support and hold the butter-like product in response to the forces of gravity when the butter-like product extends downward below the base of the device.

In embodiments, the perimeter of the base has dimensions that match or exceed the end part of the butter-like product that is supported by the at least one anchor during use.

In embodiments, the perimeter of the base has a square shape with dimensions that are equal to or greater than 1.25 inches.

In embodiments, the base can include guard walls that are configured to receive and surround an end part of the butter-like product supported by the at least one anchor during use. The guard walls can be further configured to squeeze the butter-like product axially into the at least one anchor.

In embodiments, the butter-like product comprises a full or partial stick of butter.

In another aspect, the device can be combined with a container which includes a plurality of end walls that define an internal space sized to store the butter-like product. One of the plurality of end walls can be configured with a cut-out or slot that receives the handle of the device.

In yet another aspect, a method is provided for holding and supporting a butter-like product packaged as an elongate solid or semi-solid stick or bar, which employs a device having a base with opposed first and second sides, at least one anchor that extends from the first side of the base, and an elongate handle that extends from the second side of the base. The at least one anchor of the device is manually inserted into the butter-like product such that the device holds and supports the butter-like product. The handle is gripped or held for moving and maneuvering the device with the butter-like product secured thereto.

In embodiments, the base interfaces to an end part of the butter-like product supported by the at least one anchor and also functions as a drip guard during use.

In embodiments, the base includes guard walls that receive and surround an end part of the butter-like product supported by the at least one anchor during use.

In embodiments, the manual insertion of the anchor of the device into the butter-like product can be performed with the butter-like product in a semi-solid form followed by cooling the butter-like product into a solid form that is secured and supported by the at least one anchor.

### BRIEF DESCRIPTION OF THE DRAWINGS

The subject disclosure is further described in the detailed description which follows, in reference to the noted plurality of drawings by way of non-limiting examples of the subject disclosure, in which like reference numerals represent similar parts throughout the several views of the drawings, and wherein:

FIG. 1 is a perspective view of an exemplary device for holding a butter-like product according to a first embodiment of the present disclosure.

FIG. 2 is a perspective view of another exemplary device for holding a butter-like product according to a second embodiment of the present disclosure.

FIG. 3 is a perspective view of another exemplary device for holding a butter-like product according to a third embodiment of the present disclosure.

FIG. 4 is a perspective view of an exemplary device for holding a butter-like product according to a fourth embodiment of the present disclosure.

FIG. 5 is a perspective view of another exemplary device for holding a butter-like product according to a fifth embodiment of the present disclosure.

FIG. 6 is a perspective view showing the device of FIG. 1 holding a butter-like product.

FIG. 7 is a perspective view showing the device of FIG. 2 holding a butter-like product.

FIG. 8 illustrates a container that can be combined with a butter-like product holder device of the present disclosure.

FIG. 9 is an end view of the container of FIG. 8.

FIG. 10 is a top view of the container of FIG. 8.

FIG. 11 is a perspective view showing a device holding a butter-like product disposed within the container of FIGS. 8 to 10.

### DETAILED DESCRIPTION

The present disclosure provides a holder that is adapted to hold and support a butter-like product. The holder includes a base with two opposed sides. The holder also includes at least one elongate anchor or spike or prong that extends from one side of the base and an elongate handle that extends from the opposite side of the base. The at least one anchor or spike or prong is configured for insertion into the butter-like product such that the holder can hold and support the butter-like product. The handle is configured to be gripped or otherwise held by a user's hand for moving and maneuvering the holder with a butter-like product secured thereto during use. The base is configured to interface to an end part of the butter-like product supported by the at least one anchor or spike or prong and also functions as a drip guard to keep the user's fingers or hand clear of any butter or other food drippings or residue during use. When the subject butter-like product is consumed or used up or otherwise removed from the holder, the holder can be cleaned easily and reused. For reference, a standard market available full stick of butter in the USA is approximately 1.25 inches square and 4.8 inches long. A half stick is approximately 1.25 inches square and is approximately 2.4 inches long.

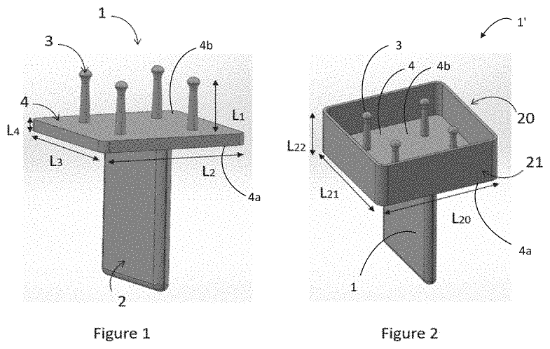

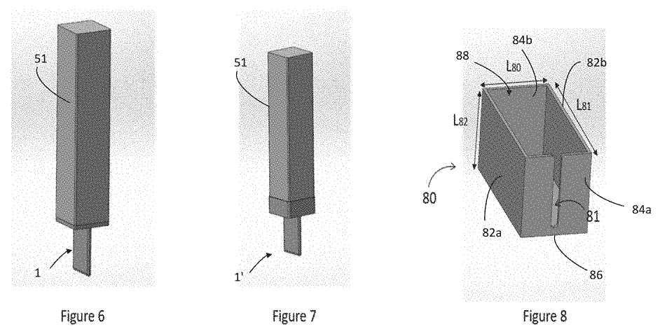

FIG. 1 illustrates an embodiment of a holder 1 according to the present disclosure, which includes a generally planar base 4 with opposed sides 4a and 4b. An elongate handle 2 extends from the side 4a of the base 4. A plurality of elongate anchors or spikes or prongs 3 extends from side 4b of the base 4. The entire holder 1 can be injection molded or machined, or similarly manufactured. The plurality of anchors or spikes or prongs 3 is configured for insertion into the butter-like product such that holder 1 can hold and support the butter-like product (FIG. 6). The handle 2 is configured to be gripped or otherwise held by a user's hand for moving and maneuvering the holder with the butter-like product secured thereto during use. The base 4 is configured to interface to an end part of the butter-like product supported by the anchors or spikes or prongs 3 and also functions as a drip guard to keep the user's fingers or hand clear of any butter-like product or other food drippings or residue during use. When the subject butter-like product is consumed or used up or otherwise removed from holder 1, holder 1 can be cleaned easily and reused.

In embodiments, the plurality of anchors or spikes or prongs 3 can be made of a food-grade material sufficiently capable of withstanding high temperatures that may be experienced in cooking in a hot pan or on a grill, etc. For example, such food-grade material can be silicone, Teflon, phenolic, Nylon, wood, or Kraton. Furthermore, the plurality of anchors or spikes or prongs 3 can be formed by overmolding with such food-grade material, or the entire holder 1 can be formed from such food-grade material. It may be desirable to make base 4 similar in dimensions to a stick of butter (dimensions mentioned above).

The shape of the anchors or spikes or prongs 3 can be generally straight posts with round bulbous heads as shown in FIG. 1. Alternatively or additionally, the anchors or spikes or prongs 3 can or can be straight spikes, tapered spikes, columns, saw-toothed, serrated, or otherwise shaped or textured to increase securement. In the embodiment of FIG. 1, four anchors or spikes or prongs 3 are employed due to the size of the holder and the subject butter-like product. In other embodiments, the number of anchors or spikes or prongs 3 can be chosen from one to a sufficient number such that displacement in the subject butter-like product is not overwhelming. The anchors or spikes or prongs 3 are configured to support and hold the subject butter-like product. The length of the anchors L1 can be as short or as long as desired based upon the nature and size of the subject butter-like product. For the case where the butter-like product is a standard stick of butter, the height L1 of the anchors or spikes or prongs 3 may be approximately 0.4″ long. For larger or longer butter-like product, the height L1 can be increased beyond 0.4″, for example to 1″ in length or longer, to increase the surface friction. If the butter-like product is longer than the height L1 of the anchors or spikes or prongs 3, it is possible for the user to easily cut off or remove a segment of the product if needed.

The base 4 can have dimensions L2 and L3 that match or exceed the end part of the butter-like product that is supported by the anchors or spikes or prongs 3 during use. In embodiments, the dimensions L2 and L3 can be equal to or greater than 1.25 inches which corresponds to the cross-sectional dimensions of a stick of butter (˜1.25 inches square). Such dimensions can provide for drip or heat protection for the user's fingers and hand when holding the handle 2 during use. The thickness L4 of the base 4 can be anywhere from a paper-thin silicone sheet to machined plastic or Teflon of larger thickness. Such thickness is predicated on the ergonomics and weight of the material used.

The handle 2 is configured to be gripped or otherwise held by a user's hand for moving and maneuvering the holder with butter-like product secured thereto during use, e.g., while applying the butter-like product to a food item or surface (e.g., crackers or baking sheet). The handle 2 can be longer or shorter, or with ergonomic features such as grips or grooves as the design requires.

The holder 1 can be easily cleaned by hand as there are no undercuts or cavities that are hard to reach. The holder 1 can be formed from dishwasher safe materials if so desired.

During use, the plurality of anchors or spikes or prongs 3 can be pushed by hand or otherwise inserted into the end of a butter-like product 51 such that holder 1 can hold and support the butter-like product as shown in FIG. 6. In embodiments, the butter-like product 51 can be softened into a semi-solid form (e.g., at room temperature) prior to inserting the plurality of anchors or spikes or prongs 3 to make such insertion easier. In this case, the butter-like product 51 can subsequently be cooled such that it solidifies around the plurality of anchors or spikes or prongs 3, creating additional security on the holder 1.

FIG. 2 illustrates an alternate embodiment of a holder 1′ that is similar to the embodiment of FIG. 1 as described above where the base 4 includes guard walls 20 and 21 that extend parallel to the plurality of anchors or spikes or prongs 3 about the perimeter of the base 4. The guard walls 20 and 21 are configured to receive and surround an end part of the butter-like product supported by the plurality of anchors or spikes or prongs 3 during use and thus provide added protection and increase securement in holding the butter-like product. Furthermore, the guard walls 20 and 21 can be configured to “squeeze” the butter-like product axially into the plurality of anchors or spikes or prongs 3. The dimensions L20, L21, and L22 of the guard walls 20 and 21 can be adapted to receive and surround the end part of the butter-like product, e.g., a minimum of 1.25 inches square to receive a 1.25 inches square end of butter. The height L22 of the guard walls 20 and 21 can be as tall or shorter or taller than the plurality of anchors or spikes or prongs 3. In an alternate embodiment, the guard walls 20 and 21 can extend from base 4 in a flared manner or drafted out wider than the periphery of base 4.

During use, the plurality of anchors or spikes or prongs 3 can be pushed manually (by hand) or otherwise inserted into the end of a butter-like product 51 such that the holder 1′ can hold and support the butter-like product as shown in FIG. 7. In embodiments, the butter-like product 51 can be permitted to soften into a semi-solid form (e.g., at room temperature) prior to inserting the plurality of anchors or spikes or prongs 3 to make such insertion easier. In this case, the butter-like product 51 can subsequently be cooled such that it solidifies around the plurality of anchors or spikes or prongs 3, creating additional security on the holder 1′.

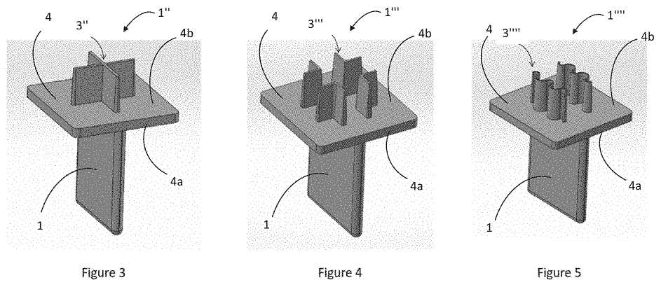

FIG. 3 shows an alternate embodiment of a holder 1″ that is similar to the embodiment of FIG. 1 as described above where the anchors or spikes or prongs are substituted by a cross-shaped anchor 3″. The cross-shaped anchor 3″ has increased surface area to create additional friction to engage and hold the subject butter-like product during use. The dimensions of the cross-shaped anchor 3″ can vary depending on the intended product. The cross-shaped anchor 3″ can have one or more holes (not shown) in the walls of the cross-shaped anchor 3″ to add additional security by allowing the butter-like product to adhere to itself and be trapped within the walls of the cross-shaped anchor 3″. In another embodiment, the cross-shaped anchor 3″ can substitute the anchors or spikes or prongs of the holder device of FIG. 2.

FIG. 4 shows an alternate embodiment of a holder 1′″ that is similar to the embodiment of FIG. 1 as described above where the anchors or spikes or prongs are substituted by L-shaped anchors 3′″. The L-shaped anchors 3′″ have increased surface area to create additional friction to engage and hold the subject butter-like product during use. The L-shaped anchors 3′″ can have one or more holes (not shown) in the walls of the L-shaped anchors 3′″ to add additional security by allowing the butter-like product to adhere to itself and be trapped within the walls of the L-shaped anchors 3′″. In another embodiment, the L-shaped anchors 3′″ can substitute the anchors or spikes or prongs of the holder device of FIG. 2.

FIG. 5 shows an alternate embodiment of a holder 1″″ that is similar to the embodiment of FIG. 1 as described above where the anchors or spikes or prongs are substituted by curvilinear-shaped anchors 3″″. The curvilinear-shaped anchors 3″″ have increased surface area to create additional friction to engage and hold the subject butter-like product during use. The curvilinear-shaped anchors 3″″ can have one or more holes (not shown) in the walls of the curvilinear-shaped anchors 3″″ to add additional security by allowing the butter-like product to adhere to itself and be trapped within the walls of the curvilinear-shaped anchors 3″″. In another embodiment, the curvilinear-shaped anchors 3″″ can substitute the anchors or spikes or prongs of the holder device of FIG. 2.

FIG. 8 shows a storage container 80 with opposed side walls 82a, 82b and opposed end walls 84a, 84b and a bottom wall 86 that form a rectangular-shaped prism internal space. The top of container 80 defines an opening 88 leading to such internal space. The end wall 84a has a cut-out or slot 81 that extends from the top edge of end wall 84a. The cut-out or slot 81 is configured to receive the handle 2 of the holder of any of FIG. 1, 2, 3, 4 or 5 as best shown in FIG. 11. In embodiments, the dimensions L80, L81, and L82 of the walls of container 80 can be adapted such that internal space is sufficiently sized to receive and store a full stick of butter (approximately 1.25 inches×1.25 inches×4.8 inches long) or a half stick (approximately 1.25 inches×1.25 inches×2.4 inches long) as shown in FIG. 11.

In embodiments, container 80 can be made from a material having relatively low friction or low adhesion properties to the butter or butter-like product, such as silicone or Teflon or the like. In an alternate embodiment, the container can be extended to include a separate compartment or section to allow storage of additional full or half-length butter sticks. In yet other embodiments, graphical and/or textual indicia can be added to the walls of the container to indicate to the user how much of the butter or butter-like product remains in the container.

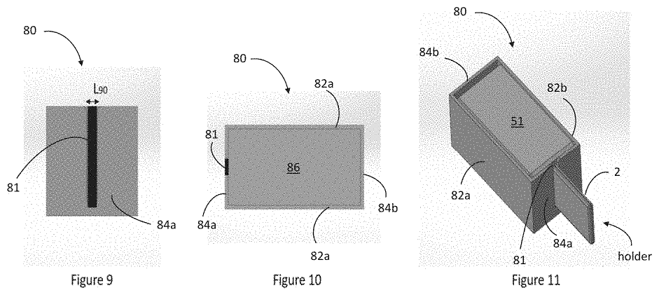

FIG. 9 shows details of slot 81. The width L90 of slot 81 should be of sufficient width to receive the handle 2 of the subject holder as best shown in FIG. 11. For example, if handle 2 is 0.2 inches in thickness, the width L90 of slot 81 can be 0.25 inches so as to receive handle 2. With the subject butter-like product 51 held by the holder and stored in the internal space of container 80 as shown in FIG. 11, the user can grab handle 2 and move the handle up slot 81 to move the butter-like product 51 through the opening 88 for removal from container 80. The reverse process can be used to move the butter-like product 51 through the opening 88 for storage of the butter-like product 51 in the internal space of the container 80. Additionally, magnets can be added to handle 2 (or a magnetic handle can be used) and to container 80 for intentional interference to create added friction to enable a more secure “lock” of handle 2 to container 80.

FIG. 10 shows a top view of container 80. In this exemplary embodiment, container 80 does not have a lid. However, a lid can be added to cover the opening 88 if so desired.

### Use:

In order to use the subject holder device and container for the embodiments described herein, a user can unwrap or unpackage all or part of the subject butter-like product (e.g., butter stick) and insert the anchor(s) of the subject holder device centered into the end of the butter-like product, for example, as seen in FIGS. 6 and 7. After inserting the subject holder device into the butter-like product, the butter-like product can be placed into container 80 or used as needed. If placed in the container, the user would then simply grab the device by handle 2 for use. The at least one anchor or spike or prong of the holder device as described herein is configured to support and hold the subject butter-like product in response to direct forces applied to the subject butter-like product, including axial and lateral forces applied to the subject butter-like product when the holder with the subject butter-like product is moved in spreading side to side motion. Such direct forces are particularly important to address if the subject butter-like product is cold or if the food item or surface (e.g., crackers or baking sheet) that the butter-like product is spread on is cold. Furthermore, the at least one anchor or spike or prong of the holder device can be configured to support and hold the subject butter-like product in response to forces of gravity if the holder device is held with the subject butter-like product extending downward below the base of the holder device.

For use with a hot pan, with the user supporting the butter-like product by holding the handle 2, the user can spread the product across the hot surface of the pan in a side to side motion. Alternatively or additionally, a dabbing or dotting motion can be used on toast or crackers if the end surface of the product is still hot or dripping.

For use with a cold pan, with the user supporting the butter-like product by holding the handle 2, the user can use the same side to side spreading motion would be used and the anchor(s) of the holder in the embodiments described above would enable security from dislodgment in a levered or sideways movement. As cold surfaces generally create more friction in a spreading or lateral movement use, the security of the anchor(s) in any of the embodiments is required or the butter-like product can be dislodged from the holder.

After use, the user can place the butter-like product and holder device back in the container 80 such that the handle 2 is received by the slot 81 and the butter-like product is contained within the container 80. In embodiments, the butter-like product can be disposed at or near the center or middle of the container 80 so as not to allow too much melted butter-like product to adhere to the interior walls of the container 80.

There have been described and illustrated herein several embodiments of a device for holding a butter-like product packaged as an elongate solid or semi-solid stick or bar, and related methods. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. A device for holding a butter-like product packaged as an elongate solid or semi-solid stick or bar, the device comprising:
a base with opposed first and second sides;
at least one anchor that extends from the first side of the base; and
an elongate handle that extends from the second side of the base;
wherein the at least one anchor is configured for insertion into the butter-like product such that the device can hold and support the butter-like product;
wherein the handle is configured to be gripped or otherwise held by a user's hand for moving and maneuvering the device with butter-like product secured thereto during use; and
wherein the base is configured to interface to an end part of the butter-like product supported by the at least one anchor during use and also functions as a drip guard during use.

2. A device according to claim 1, wherein:
the at least one anchor comprises a plurality of elongate members configured for insertion into the butter-like product during use.

3. A device according to claim 2, wherein:
the plurality of elongate members comprise generally straight posts with round bulbous heads.

4. A device according to claim 2, wherein:
the plurality of elongate members comprise straight spikes, tapered spikes, columns, saw-toothed, serrated, or otherwise shaped or textured spikes.

5. A device according to claim 1, wherein:
the at least one anchor comprises a cross-shaped anchor, a plurality of L-shaped anchors, or a plurality of curvilinear-shaped anchors.

6. A device according to claim 1, wherein:
at least the anchor of the device or the entire device is realized from a food-grade material.

7. A device according to claim 6, wherein:
the food-grade material is selected from the group consisting of silicone, Teflon, phenolic, Nylon, wood, or Kraton.

8. A device according to claim 1, wherein:
the at least one anchor has a length of at least 0.4 inches or more.

9. A device according to claim 1, wherein:
the at least one anchor is configured to support and hold the butter-like product in response to direct forces applied to the butter-like product.

10. A device according to claim 1, wherein:
the at least one anchor is configured to support and hold the butter-like product in response to the forces of gravity when the butter-like product extends downward below the base of the device.

11. A device according to claim 1, wherein:
the perimeter of the base has dimensions that match or exceed the end part of the butter-like product that is supported by the at least one anchor during use.

12. A device according to claim 1, wherein:
the perimeter of the base has a square shape with dimensions that are equal to or greater than 1.25 inches.

13. A device according to claim 1, wherein:
the base includes guard walls that are configured to receive and surround an end part of the butter-like product supported by the at least one anchor during use.

14. A device according to claim 13, wherein:
the guard walls are further configured to squeeze the butter-like product axially into the at least one anchor.

15. A device according to claim 1, wherein:
the butter-like product comprises a full or partial stick of butter.

16. A device according to claim 1 in combination with a container, wherein:
the container includes a plurality of end walls that define an internal space sized to receive the butter-like product, wherein one of the plurality of end walls has a cut-out or slot that is configured to receive the handle of the device.

17. A method of holding and supporting a butter-like product packaged as an elongate solid or semi-solid stick or bar, the method comprising:
providing a device having base with opposed first and second sides, at least one anchor that extends from the first side of the base, and an elongate handle that extends from the second side of the base;
manually inserting the at least one anchor of the device into the butter-like product such that the device holds and supports the butter-like product; and
gripping or holding the handle for moving and maneuvering the device with the butter-like product secured thereto.

18. A method according to claim 17, wherein:
the base interfaces to an end part of the butter-like product supported by the at least one anchor and also functions as a drip guard during use.

19. A method according to claim 17, wherein:
the manually inserting is performed with the butter-like product in a semi-solid form followed by cooling the butter-like product into a solid form that is secured and supported by the at least one anchor.

20. A method according to claim 17, wherein:
the base includes guard walls that receive and surround an end part of the butter-like product supported by the at least one anchor during use.
